(19) United States
(12) Patent Application Publication
(10) Pub. No.: US 2024/0136499 A1
(43) Pub. Date: Apr. 25, 2024

(54) ANODELESS ALL-SOLID-STATE BATTERY INCLUDING COMPOSITE STRUCTURE LAYER AND MANUFACTURING METHOD THEREOF

(71) Applicants: Hyundai Motor Company, Seoul (KR); Kia Corporation, Seoul (KR)

(72) Inventors: GA HYEON IM, Hwaseong-si (KR); Yun Sung Kim, Hwaseong-si (KR); So Yeon Kim, Suwon-si (KR); Kyu Joon Lee, Seoul (KR); Hong Seok Min, Yongin-si (KR); Yoon Kwang Lee, Ansan-si (KR)

(21) Appl. No.: 18/364,196

(22) Filed: Aug. 1, 2023

(30) Foreign Application Priority Data
Oct. 20, 2022 (KR) 1020220136346

(51) Int. Cl. H01M 4/133; H01M 4/04; H01M 4/134; H01M 4/1393; H01M 4/1395; H01M 4/66; H01M 10/0585

(52) U.S. Cl. CPC H01M 4/133; H01M 4/0404; H01M 4/134; H01M 4/1393; H01M 4/1395; H01M 4/661; H01M 4/663; H01M 4/667; H01M 4/668; H01M 4/669; H01M 10/0585; H01M 2004/027

(57) ABSTRACT

An anodeless all-solid-state battery includes an anode current collector, a composite structure layer positioned on the anode current collector, a solid electrolyte positioned on the composite structure layer, and a cathode positioned on the solid electrolyte, in which the composite structure layer includes a carbon layer including a carbon material, and a metal deposition layer positioned on the carbon layer and including lithiophilic metal particles.

The present application claims priority to Korean Patent Application No. 10-2022-0136346, filed Oct. 21, 2022, the entire contents of which are incorporated herein by reference.

### TECHNICAL FIELD

The present disclosure relates to an anodeless all-solid-state battery including a composite structure layer and a method of manufacturing the same.

### BACKGROUND

Rechargeable lithium-ion secondary batteries are used not only in small electronic devices such as mobile phones and laptops but also in large vehicles such as hybrid vehicles and electric vehicles. Accordingly, there is a need to develop a secondary battery having higher stability and energy density.

Existing lithium-ion secondary batteries are mostly composed of cells based on organic solvents (i.e., organic liquid electrolytes), so there may be limitations in improving the stability and energy density of existing secondary batteries.

On the other hand, all-solid-state batteries using inorganic solid electrolytes are based on a technology that excludes organic solvents, so it is possible to manufacture cells in which the cathode and anode layers and the solid electrolyte between the cathode and anode layers are arranged in a safer and simpler form. The all-solid-state battery has recently been in the spotlight because of its high energy density per volume.

In addition, research has recently been conducted on an anodeless type of storage type that deletes the anode of an all-solid-state battery and directly deposits lithium on the anode current collector. Since the anodeless all-solid-state battery does not use a conventional anode active material, the energy density per weight can be greatly increased. Therefore, compared to a lithium metal battery including a lithium metal as an anode, the anodeless all-solid-state battery has the advantages of being easy to manufacture and having low production costs.

However, if the anode active material layer and the like are simply removed and only the anode current collector is applied, lithium may not be uniformly deposited, and thus the battery is not reversibly driven. Therefore, there is a need to develop a technology capable of inducing uniform deposition of lithium.

### SUMMARY

An objective of the present disclosure is to provide an anodeless all-solid-state battery capable of improving cycle efficiency and uniformly induced deposition of lithium during charge, and a method for manufacturing the same.

The objective of the present disclosure is not limited to the objective mentioned above. The objectives of the present disclosure will become more apparent from the following description and will be realized by means and combinations thereof described in the claims.

The anodeless all-solid-state battery, according to the present disclosure, includes an anode current collector, a composite structure layer positioned on the anode current collector, a solid electrolyte positioned on the composite structure layer, and a cathode positioned on the solid electrolyte, in which the composite structure layer includes a carbon layer containing a carbon material, and a metal deposition layer disposed on the carbon layer and including a lithiophilic metal.

The anode current collector may include at least one selected from the group consisting of nickel (Ni), copper (Cu), stainless steel (SUS), and combinations thereof.

The carbon material may include at least one selected from the group consisting of a spherical nano-conductive material, a carbon nanotube (CNT), a carbon fiber, and combinations thereof.

The carbon material may have an average particle diameter (D50) in a range of 10 to 100 nm or a diameter in a range of 10 to 300 nm.

The lithiophilic metal may include at least one selected from the group consisting of silver (Ag), zinc (Zn), magnesium (Mg), bismuth (Bi), tin (Sn), gold (Au), platinum (Pt), palladium (Pd), aluminum (Al), and combinations thereof.

The metal deposition layer may have a thickness in a range of 100 to 1000 nm.

The composite structure layer may have a thickness in a range of 0.1 to 20 μm.

A lithium layer formed by depositing lithium between the carbon layer and the solid electrolyte may be further included.

The method of manufacturing an anodeless all-solid-state battery, according to the present disclosure, includes: forming a carbon layer by applying a slurry containing a carbon material, a binder, and a solvent on an anode current collector; forming a composite structure layer on an anode current collector by applying a metal deposition layer containing a lithiophilic metal on the carbon layer; and stacking a solid electrolyte and a cathode on the composite structure layer.

The carbon material may include at least one selected from the group consisting of a spherical nano-conductive material, a carbon nanotube (CNT), a carbon fiber, and combinations thereof.

The binder may include at least one selected from the group consisting of polyvinylidene fluoride (PVDF), sodium carboxymethyl cellulose (CMC), polyethylene oxide (PEO), and combinations thereof, and the solvent may include at least one selected from the group consisting of methylpyrrolidone (N-Methyl-2-Pyrrolidone, NMP), water, ethanol, isopropanol, and combinations thereof.

The slurry may contain 1% to 10% by weight of the binder with respect to the solid content.

The lithiophilic metal may include at least one selected from the group consisting of silver (Ag), zinc (Zn), magnesium (Mg), bismuth (Bi), tin (Sn), gold (Au), platinum (Pt), palladium (Pd), aluminum (Al), and combinations thereof.

The metal deposition layer may be obtained by applying a thickness in a range of 100 to 1000 nm.

The metal deposition layer may be formed by depositing the lithiophilic metal particles using any one of a vacuum deposition method, a sputtering method, and a plating method.

When the anodeless all-solid-state battery is charged, a lithium layer containing lithium may be formed between the carbon layer and the solid electrolyte.

The anodeless all-solid-state battery, according to the present disclosure, includes a composite structure layer in which a lithiophilic metal is deposited on a carbon layer, thereby filling the void between the solid electrolyte and the anode current collector and increasing the physical contact between the carbon layer and the solid electrolyte to achieve uniform lithium deposition.

In addition, the present disclosure can provide an all-solid-state battery having excellent cycle efficiency and reversibility by lowering the irreversible capacity by using a metal deposition layer containing a thin-film level lithiophilic metal.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 a schematic diagram showing an example cross-sectional view of an anodeless all-solid-state battery according to the present disclosure;

FIGS. 2A and 2B are schematic diagrams illustrating electrochemical reactions before and after charging of the anodeless all-solid-state battery according to the present disclosure;

FIGS. 3A and 3B are images taken with a scanning electron microscope (SEM) of the surface of the current collector deposited according to Comparative Example 1;

FIGS. 4A, 4B, and 4C are images taken with a scanning electron microscope (SEM) of the surface of the composite structure layer according to Example 1;

FIG. 5 is an image taken with a scanning electron microscope (SEM) of the surface of the current collector deposited according to Comparative Example 3;

FIGS. 6A and 6B are images taken with a scanning electron microscope (SEM) of the surface of the composite structure layer according to Example 2;

FIG. 7A shows sample results of the charge/discharge cycle of the anodeless all-solid-state battery according to Example 1;

FIG. 7B shows sample results of the charge/discharge cycle of the anodeless all-solid-state battery according to Comparative Example 1;

FIG. 8 shows sample results of the charge/discharge cycle of the anodeless all-solid-state battery according to Example 2;

FIG. 9 shows sample results of the charge/discharge cycle of the anodeless all-solid-state battery according to Example 1 and Comparative Example 2;

FIG. 10A shows sample efficiency results for the cycle of the anodeless all-solid-state battery according to Example 1;

FIG. 10B shows sample efficiency results for the cycle of the anodeless all-solid-state battery according to Comparative Example 1;

FIG. 11 shows sample efficiency results for the cycle of the anodeless all-solid-state battery according to Example 2;

FIG. 12 are SEM images showing components of the cross-section of the anodeless all-solid-state battery according to Example 1;

FIG. 13 are SEM images showing components of the cross-section of the anodeless all-solid-state battery according to Example 2; and

FIGS. 14A and 14B are images taken with a scanning electron microscope (SEM) of the inside of the anodeless all-solid-state battery according to Comparative Example 2.

### DETAILED DESCRIPTION

The above objectives, other objectives, features, and advantages of the present disclosure will be easily understood through the following preferred implementations in conjunction with the accompanying drawings. However, the present disclosure is not limited to the implementations described herein and may be embodied in other forms. Rather, the implementations introduced herein are provided so that the disclosed content may be thorough and complete, and the spirit of the present disclosure may be sufficiently conveyed to those skilled in the art.

The present disclosure relates to an anodeless all-solid-state battery, including a composite structure layer, and the configuration of the anodeless all-solid-state battery will be described in more detail as follows.

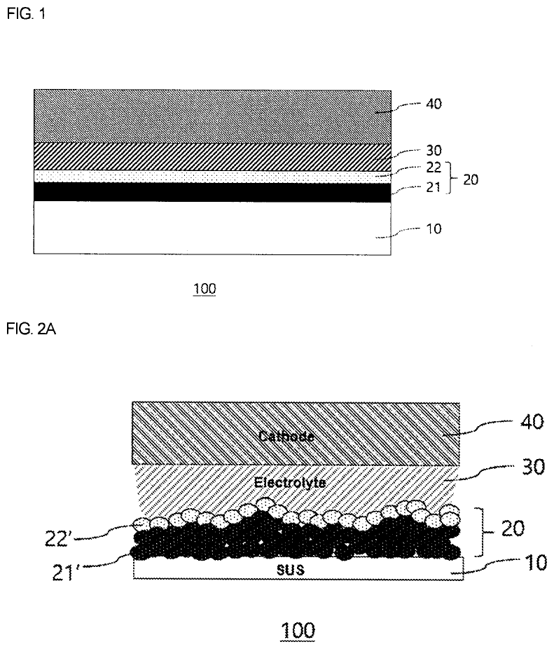

An anodeless all-solid-state battery, according to the present disclosure, will be described with reference to FIG. 1 as follows. Here, FIG. 1 schematically shows a cross-sectional view of an anodeless all-solid-state battery according to the present disclosure.

Referring to FIG. 1, the anodeless all-solid-state battery 100, according to the present disclosure, includes an anode current collector 10, a composite structure layer 20 positioned on the anode current collector 10, a solid electrolyte 30 positioned on the composite structure layer 20, and a cathode 40 positioned on the solid electrolyte 30, in which the composite structure layer 20 includes a carbon layer 21 and a metal deposition layer 22, which is positioned on the carbon layer 21, containing a lithiophilic metal.

The anode current collector 10 may be chemically stable with the solid electrolyte 30. The anode current collector 10 may be a kind of sheet-shaped substrate. Specifically, the anode current collector may be a metal including at least one selected from the group consisting of nickel (Ni), copper (Cu), stainless steel (SUS), and combinations thereof.

The thickness of the anode current collector 10 is not particularly limited but may be in a range of 1 to 20 Tim, and more specifically 5 to 15 μm.

In the anodeless all-solid-state battery 100, according to the present disclosure, a composite structure layer 20 in which a lithiophilic metal is deposited on a carbon layer 21 is applied.

The composite structure layer 20 may have a thickness in a range of 0.1 to 20 μm. When the thickness of the composite structure layer 20 is less than 1 μm, it may be too thin to effectively fill the voids. On the other hand, when the thickness of the composite structure layer 20 exceeds 20 μm, a problem of a decrease in energy density can occur.

The carbon layer 21 is positioned on the anode current collector 10 and includes a carbon material.

The carbon material may be nano-carbon particles having high electrical conductivity. Specifically, the carbon material may include at least one selected from the group consisting of a spherical nano-conductive material, a carbon nanotube (CNT), a carbon fiber, and combinations thereof.

The carbon material may have an average particle diameter (D50) in a range of 10 to 100 nm. The carbon material may have a diameter in a range of 10 to 300 nm.

The carbon layer 21 may further include a binder and a solvent.

The binder has a configuration that bonds a metal compound, a metal capable of alloying with lithium, and the like, and may include at least one selected from the group consisting of butadiene rubber (BR), nitrile butadiene rubber (NBR), hydrogenated nitrile butadiene rubber (HNBR), polyvinylidene fluoride (PVDF), polytetrafluoroethylene (PTFE), carboxymethylcellulose (CMC), polyethylene oxide (PEO), and combinations thereof. The content of the binder is not particularly limited but may be in a range of 1 to 20 parts by weight based on 100 parts by weight of the sum of the metal compound and the metal capable of alloying with lithium.

The solvent is not particularly limited and may include at least one selected from the group consisting of N-methyl-2-pyrrolidone (NMP), water, ethanol, isopropanol, and combinations thereof.

The metal deposition layer 22 is disposed on the carbon layer 21 and includes a lithiophilic metal. Here, the metal deposition layer 22 is obtained by granulating lithiophilic metals to a nano-thickness using any one of a vacuum deposition method, a stirring method, and a plating method.

The metal deposition layer 22 may have a thickness in a range of 100 to 1000 nm.

Here, when the thickness of the metal deposition layer 22 is less than 100 nm, it can be difficult to effectively fill the physical voids at the interface of the solid electrolyte 30. On the other hand, when the thickness of the metal deposition layer 22 exceeds 1000 nm, there may be a problem in that the irreversible capacity increases.

The metal deposition layer 22, according to the present disclosure, minimizes direct contact between the solid electrolyte 30 and the carbon layer 21, and the solid electrolyte 30 can first contact the lithiophilic metal, thereby providing superior performance compared to a conventional all-solid-state battery at room temperature.

The lithiophilic metal is not particularly limited but may be a metal capable of alloying with lithium. Specifically, the lithiophilic metal may include at least one selected from the group consisting of silver (Ag), zinc (Zn), magnesium (Mg), bismuth (Bi), tin (Sn), gold (Au), platinum (Pt), palladium (Pd), aluminum (Al), and combinations thereof.

The anodeless all-solid-state battery 100, according to the present disclosure, may further include a lithium layer famed by depositing lithium between the carbon layer 21 and the solid electrolyte 30.

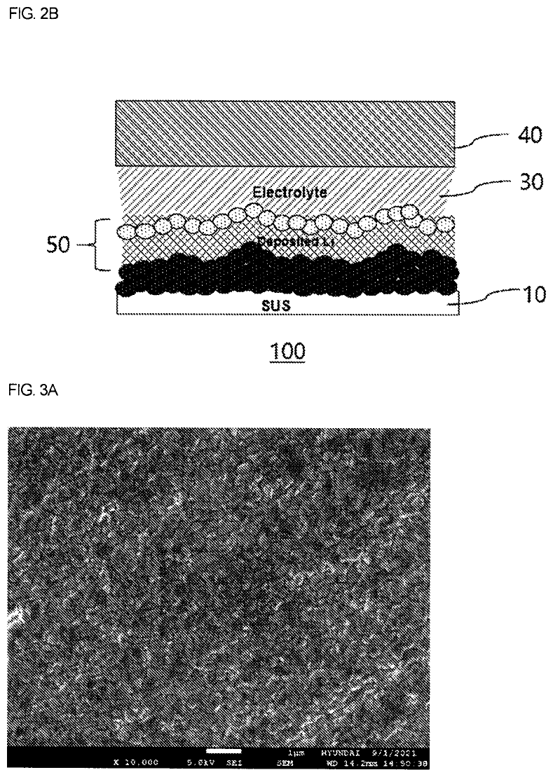

FIG. 2A shows a schematic diagram of the electrochemical reaction before charging in the anodeless all-solid-state battery according to the present disclosure.

As shown in FIG. 2A, before charging, the anode-free all-solid-state battery 100, according to the present disclosure, is sequentially stacked in the order of an anode current collector 10, a carbon layer including carbon particles 21′, a metal deposition layer including lithiophilic metal particles 22′, a solid electrolyte 30, and a cathode 40.

Accordingly, the composite structure layer 20, in which a lithiophilic metal is deposited on the carbon layer 21, according to the present disclosure, is present between the solid electrolyte 30 and the anode current collector 10.

The granular composite structure layer 20 is effective in increasing the physical contact between the lithiophilic metal and the solid electrolyte 30. In addition, the deposited lithiophilic metal particles 22′ exist in a particle size smaller than that of the solid electrolyte 30 to fill the void between the solid electrolyte 30 and the anode current collector 10.

Accordingly, the lithiophilic metal particles 22′ react with Li ions to help uniformly precipitate lithium in the lithium metal inducing layer.

FIG. 2B shows a schematic diagram of the electrochemical reaction after charging in the anodeless all-solid-state battery according to the present disclosure. Referring to FIG. 2B, lithiophilic metal particles —Li are initially formed, and then stable storage and use of the Li metal are possible.

Accordingly, when charging is applied to the anodeless all-solid-state battery 100, it can be confirmed that the lithium layer 50 is precipitated between the carbon layer 21 and the solid electrolyte 30.

The solid electrolyte layer 30 is positioned between the cathode 40 and the composite structure layer 20 to allow lithium ions to move between both components.

In the solid electrolyte layer 30, the solid electrolyte may be an oxide solid electrolyte or a sulfide solid electrolyte. However, the solid electrolyte may be preferable to use a sulfide-based solid electrolyte having high lithium-ion conductivity. The sulfide-based solid electrolyte is not particularly limited but may include Li₂S—P₂S₅, Li₂S—P₂S₅—LiI, Li₂S—P₂S₅—LiCl, Li₂S—F₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is one of Ge, Zn, and Ga), Li₂S—GeS₂, Li₂S—SiS₂—Li₃PO₄, Li₂S—SiS₂-LiₓMO_{y} (where x and y are positive numbers, M is one of P, Si, Ge, B, Al, Ga, In), Li₁₀GeP₂S₁₂, and the like.

The cathode 40 is positioned on the solid electrolyte layer 30 and may include a cathode current collector and a cathode active material layer.

The cathode current collector may be an electrically conductive plate-shaped substrate. The cathode current collector 11 may include an aluminum foil.

The cathode active material layer may include a cathode active material, a solid electrolyte, a conductive material, a binder, and the like. The cathode active material may be an oxide active material or a sulfide active material.

The oxide active material may be a rock salt layer type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, a reverse spinel type active material such as LiNiVO₄ and LiCoVO₄, an olivine type active material such as LiFePO₄, LiMnPO₄, LiCoPO₄, LiNiPO₄, silicon-containing active material such as Li₂FeSiO₄, Li₂MnSiO₄, a rock salt layer type active material in which a part of the transition metal is substituted with a dissimilar metal such as LiNi_{0.8}Co_{(0.2-x})AlₓO₂ (0<x<0.2), a spinel type active material in which a part of the transition metal is substituted with a dissimilar metal such as Li₁₊ₓMn_{2-x-y}M_{y}O₄ (M is at least one of Al, Mg, Co, Fe, Ni, Zn, and 0<x+y<2), and a lithium titanate such as Li₄Ti₅O₁₂, or the like. The sulfide active material may be copper Chevrel, iron sulfide, cobalt sulfide, nickel sulfide, or the like.

The conductive material may be carbon black, conducting graphite, ethylene black, graphene, or the like.

The binder may be butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), polyethylene oxide (PEO), or the like.

In another aspect, the present disclosure relates to a method for manufacturing an anodeless all-solid-state battery.

The method of manufacturing an anodeless all-solid-state battery, according to the present disclosure, includes: forming a carbon layer by applying a slurry containing a carbon material, a binder, and a solvent on an anode current collector; forming a composite structure layer on an anode current collector by applying a metal deposition layer containing a lithiophilic metal on the carbon layer; and stacking a solid electrolyte and a cathode on the composite structure layer.

Prior to the preparation method, detailed descriptions of a composite structure layer, including an anode current collector, a composite structure layer including the carbon layer and the metal deposition layer, a solid electrolyte, and a cathode used in an anodeless all-solid-state battery, are described above, and thus a detailed description thereof will be omitted.

First, in the step of forming the carbon layer, after preparing the slurry, the slurry may be applied to the anode current collector.

The slurry is a mixture of a carbon material, a binder, and a solvent. The carbon material may include at least one selected from the group consisting of a spherical nano-conductive material, a carbon nanotube (CNT), a carbon fiber, and combinations thereof.

The binder may include at least one selected from the group consisting of polyvinylidene fluoride (PVDF), sodium carboxymethyl cellulose (CMC), polyethylene oxide (PEO), and combinations thereof. The slurry may contain 1% to 10% by weight of the binder with respect to the solid content.

The solvent may include at least one selected from the group consisting of N-methyl-2-pyrrolidone (NMP), water, ethanol, isopropanol, and combinations thereof.

In the forming of the composite structure layer, a metal deposition layer may be applied to the carbon layer.

The coating method is not limited, but a conventional method capable of depositing a lithiophilic metal into particles on the carbon layer may be used.

The lithiophilic metal may include at least one selected from the group consisting of silver (Ag), zinc (Zn), magnesium (Mg), bismuth (Bi), tin (Sn), gold (Au), platinum (Pt), palladium (Pd), aluminum (Al), and combinations thereof.

Specifically, for the metal deposition layer, the lithiophilic metal particles may be deposited on the carbon layer by using any one of a vacuum deposition method, a sputtering method, and a plating method. In this case, the metal deposition layer may have a thickness in a range of 100 to 1000 nm to be coated on the carbon layer.

Finally, an anodeless all-solid-state battery may be manufactured by stacking a solid electrolyte and a cathode on the composite structure layer.

When the finally prepared anodeless all-solid-state battery is charged, a lithium layer including lithium may be formed between the carbon layer and the solid electrolyte.

Hereinafter, another implementation of the present disclosure will be described in more detail through Examples. The following examples are merely illustrative to help the understanding of the present disclosure, and the scope of the present disclosure is not limited thereto.

### Example 1 (Ag—C-SUS)

As shown in FIG. 1, an anodeless all-solid-state battery in which an anode current collector, a carbon layer including a carbon material, a metal deposition layer including a lithiophilic metal, a solid electrolyte, and a cathode are stacked in this order was prepared.

Here, Ag was used as the lithiophilic metal, and spherical nanopowder, which is a conductive material, was used as the carbon material. At this time, an anodeless all-solid-state battery in which a composite structure layer having a double layer was formed by sputtering a lithiophilic metal on the carbon layer was prepared.

### Example 2 (Mg-C-SUS)

The lithiophilic metal was Mg, and carbon with a spherical nanopowder was used. A double layer was prepared by depositing a lithium affinity metal on the slurry-coated carbon layer in the same manner as in Example 1.

### Comparative Example 1 (Ag-SUS)

Only lithiophilic metal (Ag) is deposited on the anode current collector, not the carbon layer. An anodeless all-solid-state battery was prepared in the same manner as in Example 1, except that a carbon layer was not used.

### Comparative Example 2 (Ag—C)

Comparative Example 2 (Ag—C) is a single composite layer in which a lithiophilic metal and a carbon material are composited and slurry-coated on an anode current collector.

### Comparative Example 3 (Mg-SUS)

Only lithiophilic metal (Mg) is deposited on the anode current collector, not the carbon layer. An anodeless all-solid-state battery was prepared in the same manner as in Example 2, except that a carbon layer was not used.

### Experimental Example 1—Scanning Electron Microscope (SEM) Analysis

First, a scanning electron microscope analysis was performed on the all-solid-state batteries according to Example and Comparative Example.

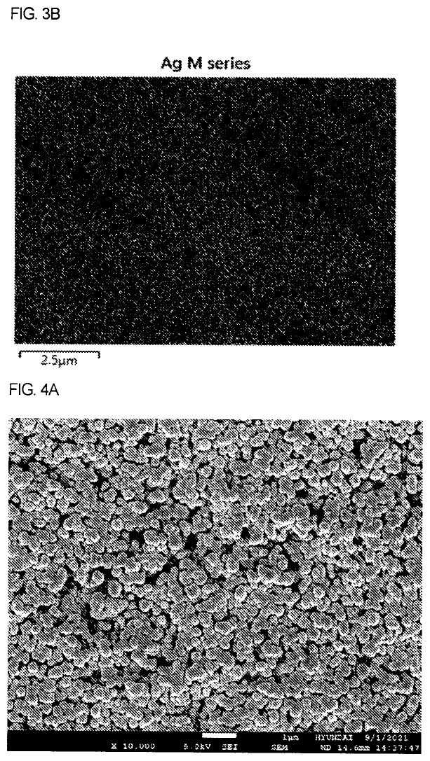

FIG. 3A is an image taken with a scanning electron microscope (SEM) of the surface of the current collector deposited according to Comparative Example 1. FIG. 3B shows the SEM-EDS result of FIG. 3A. Referring to FIG. 3A, in Comparative Example 1, it can be confirmed that the deposited metal is not granulated. In addition, it can be confirmed that Ag is uniformly deposited through FIG. 3B.

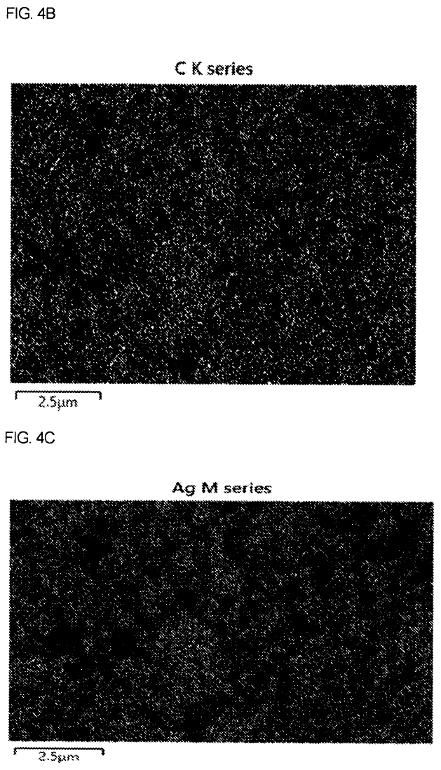

FIG. 4A is an image taken with a scanning electron microscope (SEM) of the surface of the composite structure layer according to Example 1.

FIGS. 4B and 4C show the SEM-EDS results of FIG. 4A. Referring to FIGS. 4B and 4C, in Example 1, it was confirmed that Ag and C were uniformly mixed. Therefore, in Example 1, it can be confirmed that the deposited metal is granulated.

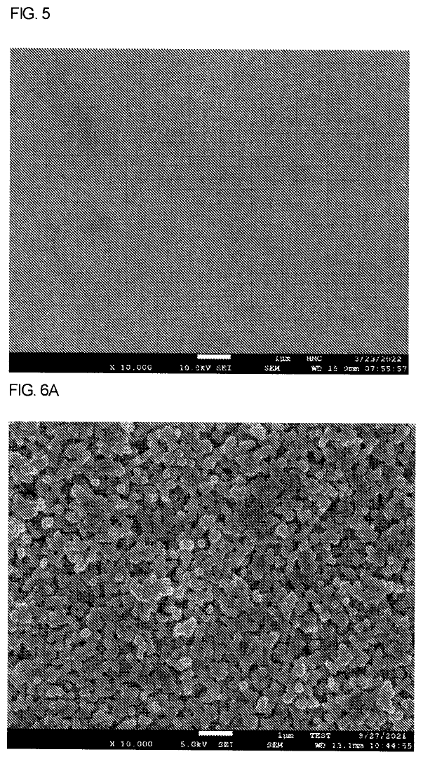

Subsequently, FIG. 5 is an image taken with a scanning electron microscope (SEM) of the surface of the current collector deposited according to Comparative Example 3.

Referring to FIG. 5, in Comparative Example 3, it can be confirmed that the deposited metal is not granulated.

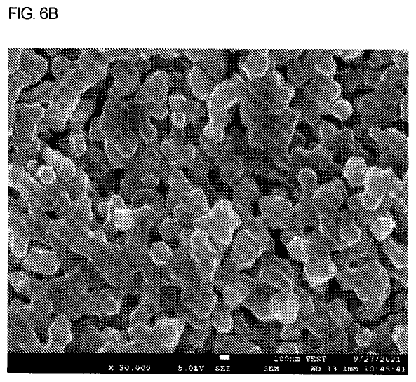

FIG. 6A is an image taken with a scanning electron microscope (SEM) of the surface of the composite structure layer according to Example 2. FIG. 6B is an enlarged view of FIG. 6A.

Referring to FIGS. 6A and 6B, in Example 2, it can be confirmed that the deposited metal is granulated.

Therefore, in the present disclosure, the efficiency is improved by increasing the physical contact between the metal and the solid electrolyte. In addition, in the present disclosure, the thickness of the deposited metal can be easily adjusted due to utilizing the sputter.

Therefore, in the present disclosure, the energy density can be improved by controlling the metal layer to have a thickness in the range of 100 nm to 1 μm.

### Experimental Example 2—Evaluation of Charging and Discharging Characteristics

Next, the charging and discharging performance of the all-solid-state batteries according to the above Example and Comparative Example were evaluated.

Specifically, the battery prepared in Example 1 was subjected to high-temperature and room-temperature half-cell cycle charging and discharging. The cycle performance of the half-cell to which the C-SUS foil (hereinafter, Ag—C-SUS) deposited with Ag to a thickness of 1000 nm is applied was evaluated under a current density of 1.17 mA/cm 2 and a deposition capacity of 3.525 mAh/cm². For comparison of cycle performance, the battery prepared in Comparative Example 1 was prepared and evaluated under the same conditions with a SUS foil (hereinafter referred to as Ag-SUS) on which simple Ag was deposited to a thickness of 1000 nm.

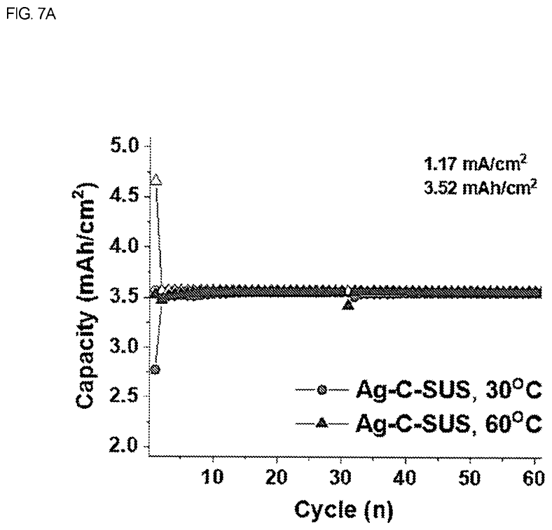

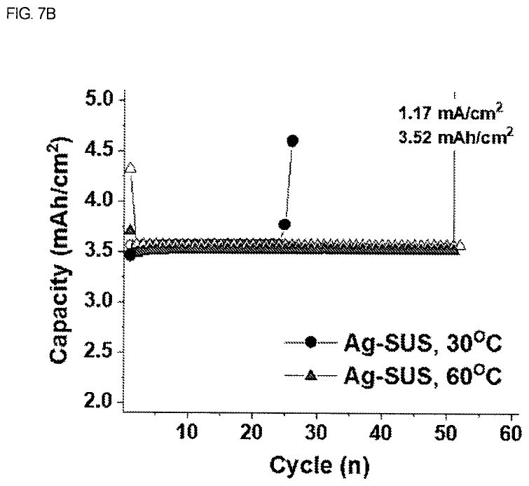

FIG. 7A shows the results of the half-cell charge/discharge cycle of the anodeless all-solid-state battery according to Example 1.

Referring to FIG. 7A, Example 1 was driven with stable life characteristics, and the average Coulomb efficiency was close to 100% at room temperature or high temperature up to 50 cycles. This means that the physical contact between the metal and the electrolyte is increased due to the particle forming of the deposition material, thereby improving the efficiency.

Next, FIG. 7B shows the results of the half-cell charge/discharge cycle of the anodeless all-solid-state battery according to Comparative Example 1.

Referring to FIG. 7B, Ag-SUS, which is a simple deposition layer, shows a behavior in which a short circuit occurs within 50 cycles at high temperature/room temperature in Comparative Example 1.

It can be confirmed that the performance of the battery may be deteriorated due to the presence of a physical void between the solid electrolyte and the hard-coated current collector, that is, a lithium deposition phenomenon that proceeds only in the contacted portion and a phenomenon caused by a dendrite growth problem.

Subsequently, the half-cell charging and discharging performance of the all-solid-state battery according to Example 2 was evaluated. The cycle performance of the half-cell was evaluated at a current density of 1.17 mA/cm 2 and a deposition capacity of 3.525 mAh/cm².

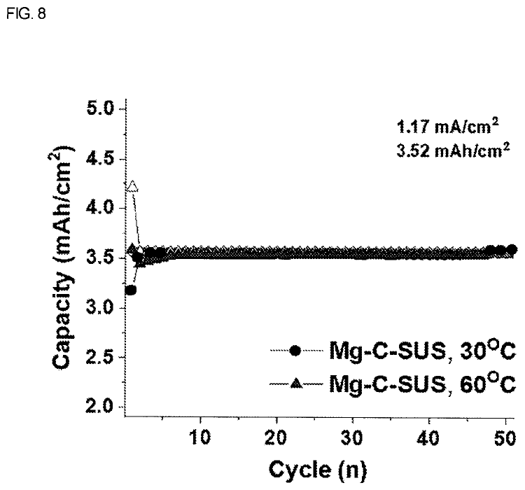

FIG. 8 shows the results of the charge/discharge cycle of the anodeless all-solid-state battery according to Example 2. Referring to FIG. 8, Example 2 was driven with stable life characteristics, and the average Coulomb efficiency was close to 100% at room temperature or high temperature up to 50 cycles.

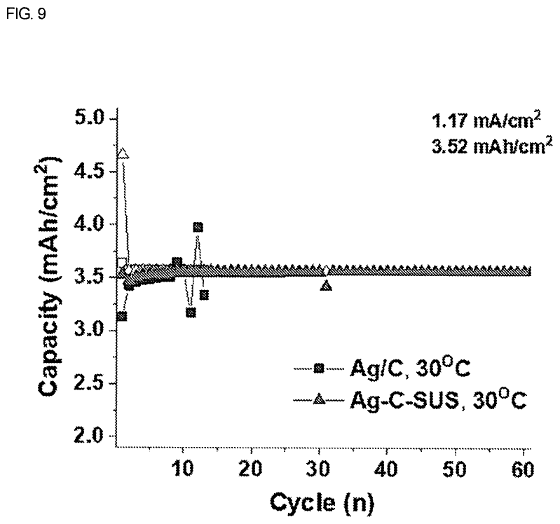

Subsequently, FIG. 9 compares the results of the half-cell charge/discharge cycle at room temperature of the anodeless all-solid-state batteries according to Example 1 and Comparative Example 2.

Referring to FIG. 9, Ag/C, which is a simple composite layer, shows a behavior in which a short circuit occurs as the diffusion of carbon surface lithium ions is very slow at room temperature, and dendrite growth is intensified at the interface between the solid electrolyte and carbon. That is, it can be seen that the composite layer itself has a room-temperature driving limit.

### Experimental Example 3—Measurement of Efficiency Per Cycle

Then, the efficiency per cycle of the all-solid-state battery according to the Examples and Comparative Examples was measured.

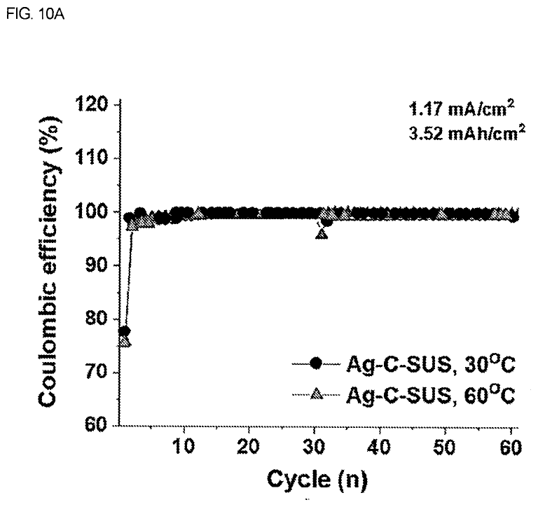

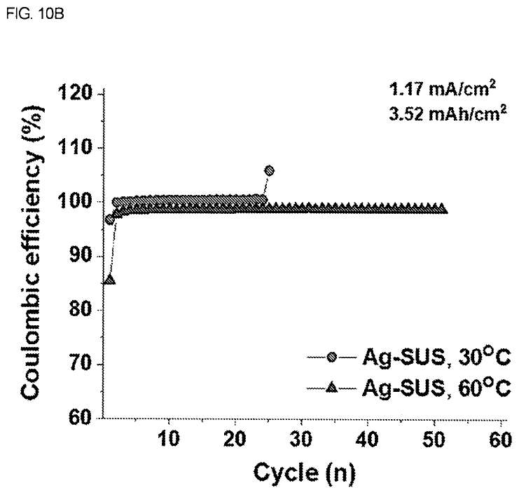

FIG. 10A shows the efficiency results for the cycle of the anodeless all-solid-state battery according to Example 1. FIG. 10B shows the efficiency results for the cycle of the anodeless all-solid-state battery according to Comparative Example 1.

Referring to FIGS. 10A and 10B, Ag-SUS, which is a simple deposited layer according to Comparative Example 1, shows an abnormal behavior in which a larger amount of desorbed than a deposited amount is generated when driving at room temperature, which is a cell short circuit. That is, Ag—C-SUS, which is the composite structure layer according to Example 1, has more stable charging and discharging, which increases physical contact, and thus uniform lithium deposition/deintercalation (high efficiency) contributes to stable charging and discharging.

Subsequently, the high-temperature/room-temperature half-cell cycle efficiency of the all-solid-state battery according to Example 2 was measured.

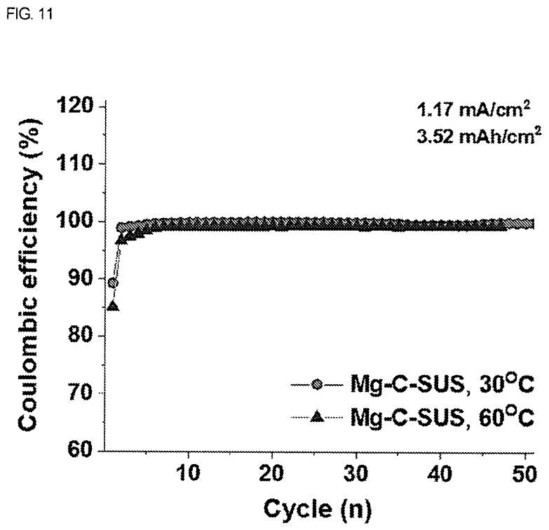

FIG. 11 shows the efficiency results for the cycle of the anodeless all-solid-state battery according to Example 2.

Referring to FIG. 11, in Example 2, it can be confirmed that the efficiency is improved by increasing the physical contact between the metal and the electrolyte due to the granulation of the deposition material.

### Experimental Example 4—Cross-Sectional Analysis of all-Solid-State Battery

Subsequently, after performance evaluation, cross-sections of the all-solid-state batteries according to Examples and Comparative Examples were analyzed. Specifically, the evaluation was conducted at a current density of 1.17 mA/cm², a deposition capacity of 3.525 mAh/cm², and a temperature of 30° C.

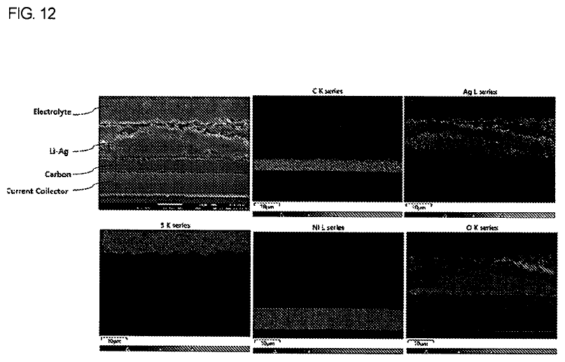

FIG. 12 is an analysis of the components of the cross-section of the anodeless all-solid-state battery according to Example 1.

Referring to FIG. 12, in Example 1, it can be confirmed that after the initial deposition of the half-cell, the metal Ag (or Mg) on the carbon layer reacts with Li ions to help uniform precipitation of lithium in the lithium metal inducing layer, and lithium is uniformly deposited as Ag—Li.

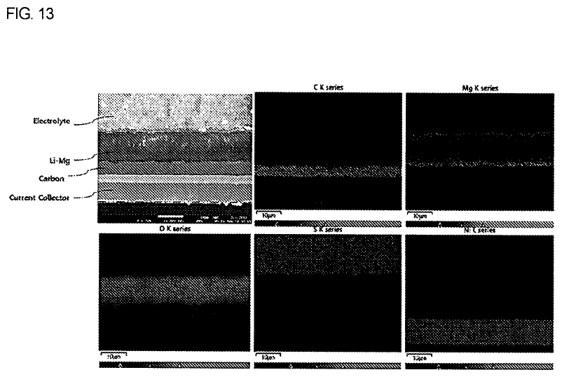

FIG. 13 is an analysis of the components of the cross-section of the anodeless all-solid-state battery according to Example 2. Referring to FIG. 13, in Example 2, it can be confirmed that lithium is uniformly deposited on the carbon layer after the initial deposition of the half-cell.

Then, the internal appearance of the anodeless all-solid-state battery, according to Comparative Example 2, was analyzed.

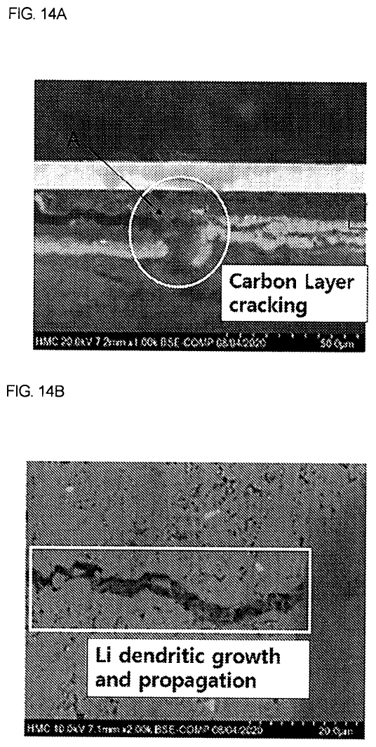

FIG. 14A is an image taken with a scanning electron microscope (SEM) of an internal crack during room temperature driving of Comparative Example 2. FIG. 14B is an enlarged view of area A of FIG. 14A.

Referring to FIGS. 14A and 14B, it can be seen that in Comparative Example 2, lithium-ion diffusion on the carbon surface was very slow at room temperature, so dendrites were deepened at the solid electrolyte and carbon interface, and the carbon layer was cracked. Therefore, Comparative Example 2 shows the limitations of the normal temperature driving of the simple composite layer structure.

Therefore, according to the present disclosure, the voids between the electrolyte and the current collector are filled through the composite structure layer granulated with lithiophilic metal and carbon, and the physical contact between the coated current collector and the solid electrolyte is increased, thereby (i) improving efficiency and uniformly inducing lithium deposition during charging and (ii) greatly affecting the overall characteristics of the battery.

In addition, since it is possible to design a precise deposition thickness with a nano-scale metal deposition layer using sputtering, the cell energy density can be improved by minimizing the volume of the conventionally used anode material, and the reversibility can be improved by lowering the irreversible capacity. As a result, the double-layer structure technology can be a source technology for an all-solid-state battery that can be operated at room temperature by helping to suppress the lithium dendrite growth that occurs at the interface.

Although the implementation of the present disclosure has been described above, it will be understood by those skilled in the art that the present disclosure may be implemented in other specific foams without changing the technical spirit or essential features thereof. Therefore, it should be understood that the implementations described above are illustrative in all respects and not restrictive.

What is claimed is:

1. An anodeless all-solid-state battery comprising:
an anode current collector;
a composite structure layer positioned on the anode current collector;
a solid electrolyte positioned on the composite structure layer; and
a cathode positioned on the solid electrolyte,
wherein the composite structure layer includes:
a carbon layer containing a carbon material, and
a metal deposition layer positioned on the carbon layer and containing a lithiophilic metal.

2. The anodeless all-solid-state battery of claim 1, wherein the anode current collector comprises at least one of nickel (Ni), copper (Cu), stainless steel (SUS), or combinations thereof.

3. The anodeless all-solid-state battery of claim 1, wherein the carbon material comprises at least one of a spherical nano-conductive material, a carbon nanotube (CNT), a carbon fiber, or combinations thereof.

4. The anodeless all-solid-state battery of claim 1, wherein the carbon material has an average particle diameter (D50) in a range of 10 to 100 nm or a diameter in a range of 10 to 300 nm.

5. The anodeless all-solid-state battery of claim 1, wherein the lithiophilic metal comprises at least one of silver (Ag), zinc (Zn), magnesium (Mg), bismuth (Bi), tin (Sn), gold (Au), platinum (Pt), palladium (Pd), aluminum (Al), or combinations thereof.

6. The anodeless all-solid-state battery of claim 1, wherein the metal deposition layer has a thickness in a range of 100 to 1000 nm.

7. The anodeless all-solid-state battery of claim 1, wherein the composite structure layer has a thickness in a range of 0.1 to 20-μm.

8. The anodeless all-solid-state battery of claim 1, further comprising a lithium layer formed between the carbon layer and the solid electrolyte through precipitation of lithium.

9. A method of manufacturing an anodeless all-solid-state battery, the method comprising:
forming a carbon layer by applying a slurry including a carbon material, a binder, and a solvent on an anode current collector;
forming a composite structure layer on the anode current collector by applying a metal deposition layer comprising lithiophilic metal particles on the carbon layer; and
stacking a solid electrolyte and a cathode on the composite structure layer.

10. The method of claim 9, wherein the carbon material comprises at least one of a spherical nano-conductive material, a carbon nanotube (CNT), a carbon fiber, or combinations thereof.

11. The method of claim 9, wherein the binder comprises at least one of polyvinylidene fluoride (PVDF), sodium carboxymethyl cellulose (CMC), polyethylene oxide (PEO), or combinations thereof, and
the solvent comprises at least one of N-methyl-2-pyrrolidone (NMP), water, ethanol, isopropanol, or combinations thereof.

12. The method of claim 9, wherein the slurry comprises 1% to 10% by weight of the binder with respect to a solid content thereof.

13. The method of claim 9, wherein the lithiophilic metal particles are made from at least one of silver (Ag), zinc (Zn), magnesium (Mg), bismuth (Bi), tin (Sn), gold (Au), platinum (Pt), palladium (Pd), aluminum (Al), or combinations thereof.

14. The method of claim 9, wherein the metal deposition layer is applied to have a thickness in a range of 100 to 1000 nm.

15. The method of claim 9, wherein the metal deposition layer is formed by depositing the lithiophilic metal particles using any one of a vacuum deposition method, a sputtering method, and a plating method.

16. The method of claim 9, wherein based on the anodeless all-solid-state battery being charged, a lithium layer including lithium is formed between the carbon layer and the solid electrolyte.
